(19) United States
(12) Patent Application Publication
(10) Pub. No.: US 2025/0262866 A1
(43) Pub. Date: Aug. 21, 2025

(54) SYSTEM AND METHOD FOR REDUCING INK WASTE IN AQUEOUS INKJET PRINTERS

(71) Applicant: Xerox Corporation, Norwalk, CT (US)

(72) Inventors: Douglas K. Herrmann, Webster, NY (US); Jorge A. Alvarez, Webster, NY (US); Seemit Praharaj, Webster, NY (US); Jason M. LeFevre, Penfield, NY (US); Anthony S. Condello, Webster, NY (US)

(21) Appl. No.: 18/444,036

(22) Filed: Feb. 16, 2024

(51) Int. Cl. B41J 2/185; B41J 2/17; B41J 2/175; B41J 2/21

(52) U.S. Cl. CPC B41J 2/185; B41J 2/1707; B41J 2/17596; B41J 2/2103; B41J 2002/1856

(57) ABSTRACT

An aqueous inkjet printer collects different colors of ink purged from the manifolds of printheads in the printer to form process black ink in a purged ink container. The process black ink is provided selectively or solely to printheads in the printer that eject ink to form black color separations in ink images. A supply of black ink can also be fluidly connected to the purged ink container to provide black ink to the purged ink container to alter the process black ink stored in the purged ink container.

### TECHNICAL FIELD

This disclosure relates generally to devices that produce ink images on media, and more particularly, to the reducing of ink waste produced by such printers.

### BACKGROUND

Inkjet imaging devices, also known as inkjet printers, eject liquid ink from printheads to form images on an image receiving surface. The printheads include a plurality of inkjets that are arranged in an array. Each inkjet has a thermal or piezoelectric actuator that is coupled to a printhead controller. The printhead controller generates firing signals that correspond to digital data content that define the images. The actuators in the printheads respond to the firing signals by expanding into an ink chamber fluidly connected to a nozzle to eject ink drops from the nozzle onto an image receiving surface to form an ink image that corresponds to the digital image content used to generate the firing signals. The image receiving surface is usually a continuous web of media material or a series of media sheets.

Inkjet printers used for producing color images typically include multiple printhead modules. Each printhead module includes one or more printheads that typically eject a single color of ink. In a typical inkjet color printer, four printhead modules are positioned in a process direction with each printhead module ejecting a different color of ink. The four ink colors most frequently used are cyan, magenta, yellow, and black. The common nomenclature for such printers is CMYK color printers. Some CMYK color printers have two printhead modules that print each color of ink. The printhead modules that print the same color of ink are offset from each other by one-half of the distance between adjacent inkjets in the cross-process direction to double the number of pixels per inch to increase the density of a line of the color of ink ejected by the printheads in the two modules. As used in this document, the term “process direction” means the direction of movement of the image receiving surface as it passes the printheads in the printer and the term “cross-process direction” means a direction that is perpendicular to the process direction in the plane of the image receiving surface.

Inkjets, especially those in printheads that eject aqueous inks, need to fire regularly to help prevent the ink in the nozzles from drying. Sometimes the nozzles in a printhead dry because the inkjets have ejected a substantial amount of ink to form high coverage areas in an ink image. The operation of a high proportion of inkjets in a portion of the faceplate on the printhead can produce a high number of satellite drops that tend to adhere to the faceplate. Satellite drops are small ink drops that separate from the larger drops that travel from the nozzles to the image receiving substrates. The buildup of these satellite drops on a faceplate can clog nozzles in the faceplate. Additionally, if the inkjets in a printhead are not operated frequently enough, such as when low ink area coverage image portions are printed, then the ink within an inkjet can dry and render the inkjet inoperative. To maintain the operational status of the inkjets, the printhead modules are moved from positions opposite the path of the image receiving substrates to printhead maintenance stations where the printheads are purged. Purging a printhead means a pressurized gas or liquid is applied to the ink supply chambers within a printhead to force ink from the chamber into the nozzles where the ink is emitted from the nozzles onto the faceplate. One or more wipers are then moved across the faceplate to remove the purged ink from the faceplate into a waste ink receptacle. The waste ink receptacle is periodically removed form the printer so the waste ink can be disposed. The deposed ink is not only an expense for the customer that does not result in productive output but it is also a less green solution since the ink is typically flushed from the receptacle into a waste water system. This action impacts the sustainability of the system. Thus, inkjet printers would benefit from being able to treat waste ink in a manner that reduces the production of ink waste by the printers.

### SUMMARY

A color inkjet printer is configured to collect and reuse waste ink in a manner that reduces the production of ink waste by the printer. The color inkjet printer includes a plurality of printheads; a plurality of aqueous ink supplies, each printhead being fluidly connected to at least one of the ink supplies in the plurality of ink supplies and at least some of the ink supplies storing ink having a different color of ink than ink stored in at least some other ink supplies; a first purged ink container that is fluidly connected to at least some of the printheads in the plurality of printheads to receive different colors of aqueous ink purged from a manifold in the printheads connected to the first purged ink container; and at least one printhead in the plurality of printheads that is configured to eject black colored ink, the at least one printhead configured to eject black colored ink is fluidly connected to the first purged ink container to receive process black ink from the first purged ink container.

A method of operating a color inkjet printer collects and reuses waste ink in a manner that reduces the production of ink waste by the printer. The method includes fluidly connecting a first purged ink container to at least some printheads in the inkjet printer to receive different colors of aqueous ink purged from manifolds in the printheads connected to the first purged ink container; and operating at least one printhead configured to receive process black ink from the first purged ink container to form at least a portion of a black color separation in ink images printed by the inkjet printer.

### BRIEF DESCRIPTION OF THE DRAWINGS

The foregoing aspects and other features of a color inkjet printer and color inkjet printer operational method that reduces the ink waste produced by an inkjet printer are explained in the following description, taken in connection with the accompanying drawings.

FIG. 1 is a schematic drawing of a color aqueous inkjet printer that collects and reuses waste ink from printhead manifolds in a manner that reduces the production of ink waste by the inkjet printer.

FIG. 2 is a schematic diagram of the ink flows in the aqueous inkjet printer of FIG. 1.

FIG. 3 is a bottom view of a printhead that ejects two different colors of aqueous ink that can be used in the printer of FIG. 1.

FIG. 4 is a schematic diagram of ink flows used in an alternative embodiment of the aqueous inkjet printer of FIG. 1.

FIG. 5 is a flow diagram of a process for operating the aqueous inkjet printer of FIG. 1.

### DETAILED DESCRIPTION

For a general understanding of the environment for the printer and the printer operational method disclosed herein as well as the details for the printer and the printer operational method, reference is made to the drawings. In the drawings, like reference numerals have been used throughout to designate like elements. As used herein, the word “printer” encompasses any apparatus that ejects ink drops onto different types of media to form ink images.

The inkjet printer described below sustainably reuses ink from the purging processes used in production inkjet printers. To keep printheads operating optimally, periodic purge functions are performed to ensure the print systems and the printheads are clear. Two distinct purge options are used. One is an inkjet stack purge and the second is a manifold purge. The inkjet stack purge applies pneumatic pressure to the manifold of a printhead to force ink through the inkjets of a printhead to remove any dried or clogged ink. The ink and debris are wiped from the faceplate of the printhead and deposited in a purge tray and then directed to a purged ink container. This container is removed from the printer on a periodic basis on when the container is approaching a full level and the purged ink is discarded into a water drain or the like. Inkjet stack purges are usually performed when image quality metrics indicate that the number of inoperative inkjets is approaching a threshold that jeopardizes the effectiveness of compensation techniques.

A manifold purge applies pneumatic pressure to the printhead manifold but an outlet from the manifold is opened so ink that resides in the printhead body circulates through and then out of the manifold so the ink is not forced into the inkjets. The pressures and movement of the ink during manifold purges benefit the printheads, help remove bubbles from the ink, and can extend the time between inkjet stack purges. These manifold purges can occur at periodic intervals or on demand. The ink purged solely through the manifold is free of contaminants and is ink that could be reused in the printing process; however, this ink is typically directed to the same purged ink container that holds the ink purged from the inkjets. Since ink purged from the manifold is mixed with the ink purged from the inkjets, this ink can no longer be used in the printheads without introducing debris into the printheads.

The ink purged from the manifolds is usually a combination of cyan, yellow, magenta (CYM) and black (K) since these ink colors are the most commonly used inks in inkjet printers. The resulting ink is sometimes called process black because the combination approximates the color black. The inkjet printer described below collects the ink purged through the manifolds and stores them in a container separate from the container in which the ink purged through the inkjets is stored. The process black ink stored in the container to which ink purged through the manifolds is then supplied to the printheads ejecting black ink when a lower quality black ink can be tolerated such as the printing of forms, invoices, mail promotional materials, product instructions, or even low end book publishing, such as coloring books. This process black ink can be optimized by controlling the ink colors and quantities provided to the process black ink container. Additionally, black ink (K) can be supplied to the process black ink container to further improve process black ink characteristics if necessary. Such a printer not only lowers the cost of printing for a customer but can also help them meet ever-increasing sustainability goals by both reusing ink purged from the printhead manifolds to produce useful process black ink and reducing the amount of purged ink that needs discarding.

While process black ink is produced and used for printing in some solid inkjet (SIJ) printers, the process black ink is made with inkjet stack purged inks. The SIJ printheads can tolerate the use of inkjet stack purged inks because those printheads have a lower resolution. Typically, SIJ printheads have a resolution of 300 dpi so higher resolutions are obtained by staggering the printheads in the cross-process direction at some sub-interval of the distance between adjacent inkjets in the printheads. Additionally, the viscosity of the melted solid ink is very different than the inks used in aqueous inkjet printers since it contains paraffin or some other waxy material that solidifies at typical ambient room temperatures. To accommodate the thicker SIJ inks, the printheads in SIJ printers have wider ink channels than those in aqueous inkjet printheads. The aqueous inkjet printer described more fully below has printheads with a typical resolution of 1200 dpi and narrow ink channels. Therefore, only by differentiating between the ink purged from manifolds and the ink purged from inkjet stacks can process black ink be produced and used in the printer without adversely impacting the operation of the printheads.

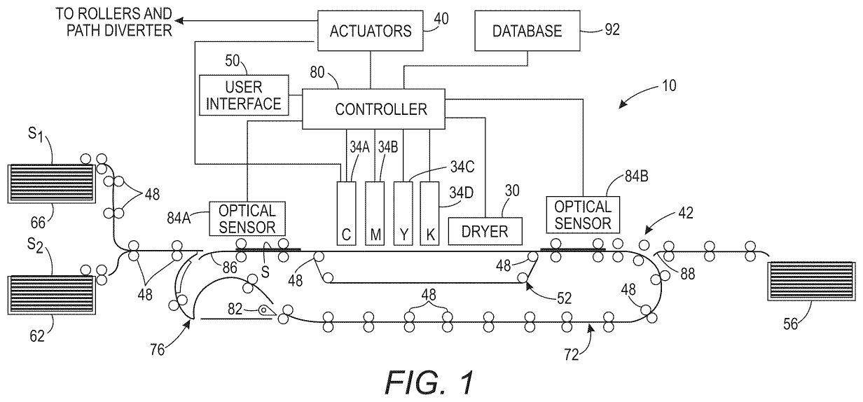

FIG. 1 depicts a high-speed color aqueous inkjet printer 10 that stores aqueous ink purged from manifolds in an ink container that is separate from the ink container that stores ink purged from inkjets. As used in this document, the term “process black ink” means ink formed by mixing differently colored aqueous inks so the resulting ink approximates the appearance of black ink. The process ink is then supplied to printheads ejecting black ink when lower levels of black ink quality can be used in a manner more fully described below.

The printer 10 shown in FIG. 1 is an aqueous inkjet printer that directly forms an ink image on a surface of a media sheet stripped from one of the supplies of media sheets S1 or S2 and the sheets S are moved through the printer 10 by the controller 80 operating one or more of the actuators 40 that are operatively connected to rollers or to at least one driving roller of conveyor 52 that comprise a portion of the media transport 42 that passes through the print zone of the printer. In one embodiment, each printhead module has only one printhead that has a width that corresponds to a width of the widest media in the cross-process direction that can be printed by the printer. In other embodiments, the printhead modules have a plurality of printheads with each printhead having a width that is less than a width of the widest media in the cross-process direction that the printer can print. In these modules, the printheads are arranged in an array of staggered printheads or a linear array of printheads that abut one another in the cross-process direction to enable media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. Although printer 10 is depicted with only two supplies of media sheets, the printer can be configured with three or more sheet supplies, each containing a different type or size of media.

With further reference to FIG. 1, the printed image exits the print zone of printer 10 and passes under an image dryer 30 after the ink image is printed on a sheet S. As used in this document, the term “print zone” means an area of a media transport opposite the printheads of an inkjet printer. The image dryer 30 can include an infrared heater, a heated air blower, air returns, or combinations of these components to heat the ink image and at least partially fix an ink image to the sheet S. An infrared heater applies infrared heat to the printed image on the surface of the sheet S to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer.

Controller 80 operates at least one of the actuators 40 to rotate a pivoting member at position 88 to either direct a sheet to receptacle 56 or to return path 72. A sheet S is moved by the rotation of rollers along the return path 72 in a direction opposite to the direction of movement in the process direction past the printheads. Pivoting member 82 is operated by the controller 80 to either direct the sheet along a curved portion of the return path 72 into inverter 76 so the sheet is turned over for duplex printing or along the straight portion of the return path 72. When the sheet follows the straight portion, the inverter 76 is bypassed and the side of the sheet previously printed can be printed again. The controller operates one of the actuators 40 to move the pivoting member 82 clockwise to direct a sheet into the inverter 76 and counterclockwise to bypass the inverter. Regardless of whether the substrate is inverted or not, it merges into the job stream being carried by the media transport 42 when controller 80 operates another actuator 40 to rotate pivoting member 86 to provide ingress of a sheet S from return path 72 to the job stream entering the print zone.

As further shown in FIG. 1, the printed media sheets S not diverted to the duplex path 72 are carried by the media transport to the sheet receptacle 56 in which they are be collected. Before the printed sheets reach the receptacle 56, they pass by an optical sensor 84B. The optical sensor 84B generates image data of the printed sheets and this image data is analyzed by the controller 80 to detect streakiness in the printed images on the media sheets of a print job. Additionally, sheets that are printed with test pattern images are printed at intervals during the print job. Image data of these test pattern images generated by optical sensor 84B are analyzed by the controller 80 to determine which inkjets, if any, that were operated to eject ink into the test pattern did in fact do so, and if an inkjet did eject an ink drop whether the drop landed at its intended position with an appropriate mass. Any inkjet not ejecting an ink drop it was supposed to eject or ejecting a drop not having the correct mass or landing at an errant position is called an inoperative inkjet in this document. The controller can store data identifying the inoperative inkjets in database 92 operatively connected to the controller 80. These sheets printed with the test patterns are sometimes called run-time missing inkjet (RTMJ) sheets and these sheets are discarded from the output of the print job. A user can operate the user interface 50 to obtain reports displayed on the interface that identify the number of inoperative inkjets and the printheads in which the inoperative inkjets are located. For sheets that are not inverted and merged into the job stream by the operation of pivoting member 86, optical sensor 84A generates image data of the printed side and the controller 80 uses that image data to register the sheets and to operate the ejectors in the printhead to further print images on the previously printed sheet sides. The optical sensors 84A and 84B can be a digital camera, an array of LEDs and photodetectors, or other devices configured to generate image data of a passing surface. While FIG. 1 shows the printed sheets as being collected in the sheet receptacle 56, they can be directed to other processing stations (not shown) that perform tasks such as folding, collating, binding, and stapling of the media sheets.

Operation and control of the various subsystems, components and functions of the machine or printer 10 are performed with the aid of a controller or electronic subsystem (ESS) 80. The ESS or controller 80 is operatively connected to the components of the printhead modules 34A-34D (and thus the printheads), the actuators 40, and the dryer 30. The ESS or controller 80, for example, is a self-contained computer having a central processor unit (CPU) with non-transitory, computer readable media, such as electronic data storage, and a display or user interface (UI) 50. The ESS or controller 80, for example, includes a sensor input and control circuit as well as a pixel placement and control circuit. In addition, the controller 80 reads, captures, prepares, and manages the image data flow between image input sources, such as a scanning system or an online or a work station connection (not shown), and the printhead modules 34A-34D. As such, the ESS or controller 80 is the main multi-tasking processor for operating and controlling all of the other machine subsystems and functions, including the printing process.

The controller 80 can be implemented with general or specialized programmable processors that execute programmed instructions. The instructions and data required to perform the programmed functions can be stored in non-transitory, computer readable medium associated with the processors or controllers. The processors, their memories, and interface circuitry configure the controllers to perform the operations described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 80 from either a scanning system or an online or work station connection for processing and generation of the printhead control signals output to the printhead modules 34A-34D. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

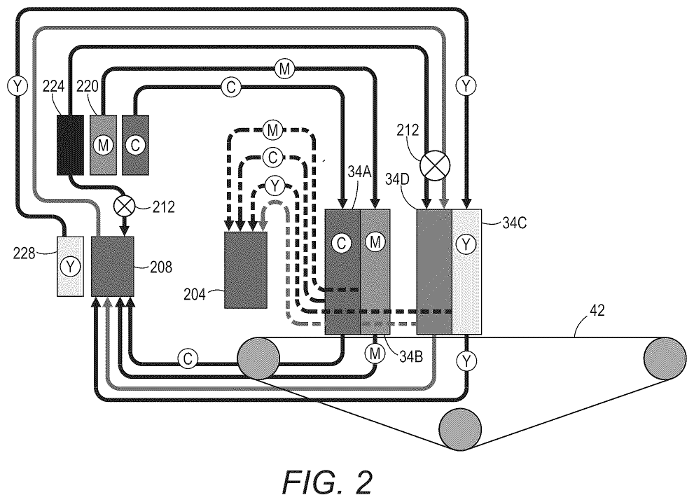

The ink supply flow paths and the purged ink flow paths in the printer of FIG. 1 are shown in FIG. 2. The printhead modules 34A to 34D are shown in a different order than depicted in FIG. 1 to facilitate the depiction of the flow paths. The ink produced by inkjet stack purges of the printheads in the modules 34A to 34D are illustrated by the dashed flow paths in the figure. These flow paths empty into a waste ink receptacle 204. The receptacle 204 is configured for removal from the inkjet printer from time to time and emptied in a known matter to discard the purged ink and the debris it contains. The ink purged from the manifolds of the printheads in the modules 34A to 34D follow the flow paths depicted with the solid arrows and these flow paths empty into a process black ink container 208. There the inks combine to form process black ink. As noted previously, this process black ink can be optimized by the controller 80 performing the manifold purges of the printheads in the various printhead modules to control the ink colors and quantities provided to the process black ink container 208. The cyan ink supply 216 is fluidly connected to the printheads in the cyan printhead module 34A, the magenta ink supply 220 is fluidly connected to the printheads in the magenta printhead module 34B, and the yellow ink supply 228 is fluidly connected to the printheads in the yellow printhead module 34C. The process black container 208 and the black ink supply 224 are fluidly connected to the printheads in printhead module 34D through a valve 212. The controller 80 is operatively connected to the valve 212 to operate the valve so either process black ink is supplied to the printheads in module 34D from the process black ink container 208 or black ink is supplied to the printheads in module 34D from the black ink supply 224. Also, as noted previously, the process black ink is used when the higher quality black ink from the black ink supply 224 is not required. Additionally, the black ink supply 224 is fluidly connected to the process black ink container 208 through a second valve 212. The controller 80 is also operatively connected to the second valve 212 to control whether black ink from the supply 224 is provided to the process black ink in the container 208 to upgrade the quality of the process ink in the container.

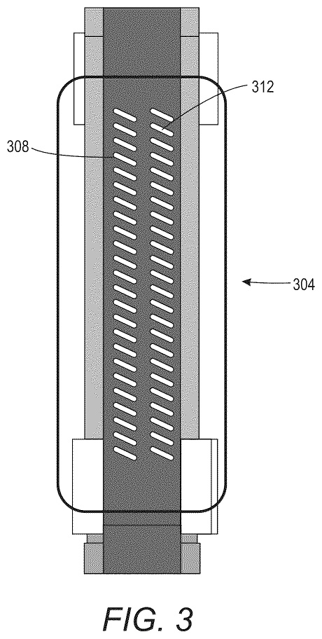

Some inkjet printers are used strictly for print jobs that do not require the high image quality prints such as those provided by the printer shown in FIG. 1. Because the density of the dots per inch (dpi) in the lines produced by such printers can be lower than those produced by the staggered printheads of the printer shown in FIG. 1, two colors can be printed by a single printhead. Such a printhead is shown in FIG. 3. The printhead 304 shown in FIG. 3 has a first array of inkjets 308 that eject a first color of ink and a second array of inkjets 312 that eject a second color of ink. The printheads in such a printer can be fluidly connected in a manner similar to that shown in FIG. 2 so the manifolds are fluidly connected to a process black container to collect and form process black ink from the ink purged from the manifolds while the inkjet stack purged ink can be directed to a waste ink receptacle. If the printer is used strictly for print jobs that do not require the higher quality black (K) ink, then a printhead 304 that ejects a colored ink, such as yellow, and black ink can have the array of inkjets that ejects black ink connected to the process black ink container alone. That is, no black ink supply 224 is required for such a printer unless a black ink supply 224 is fluidly connected to the process black ink container so the controller can open the valve 212 and provide black (K) ink to the process black ink container to improve the quality of the process black ink supplied from the container.

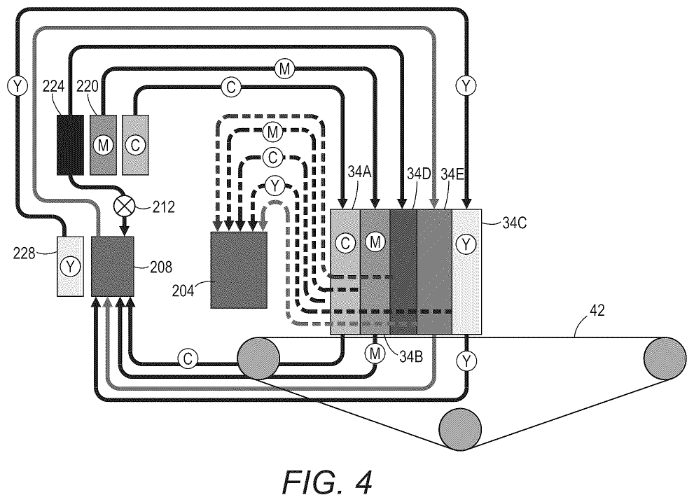

Following these principles, an alternative embodiment of the printer 10 shown in FIG. 1 can be implemented. The ink connections of such an alternative embodiment is shown in FIG. 4. In this alternative embodiment, the black (K) printhead module 34D has been moved in the print zone and a process black printhead module 34E has been added. The black printhead module is fluidly connected to the black (K) ink supply 224 for the provision of black ink while the process black printhead module 34E is fluidly connected to the process black container 208 to receive process black ink. During print job operations that do not require high quality black (K) ink, the controller 80 generates firing signals for operating the inkjets in the printhead module 34E to eject process black ink rather than black (K) ink for the black color separation of the image. Such selective operation of the process black printhead module and the black printhead module can be done with regard to different images within a print job or even to portions of the black color separation within an image. Again, the second valve 212 can be used to alter the quality of the process black ink using ink from the black ink supply 224 but if such adjustment in process black ink is not required, then the second valve 212 can be removed from the embodiment.

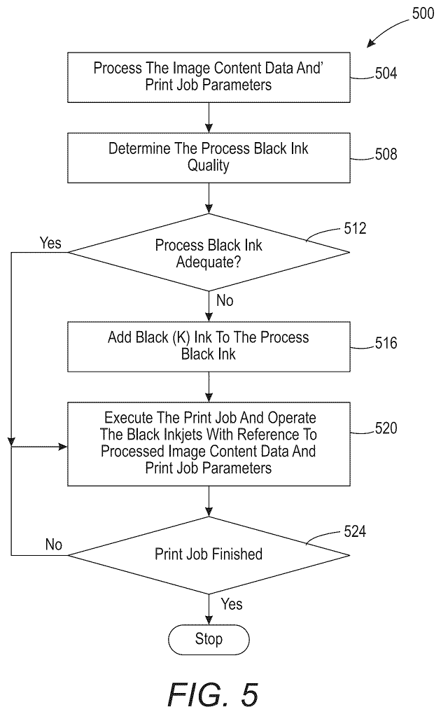

A process 500 for operating the inkjet printer of FIG. 1 to produce and use process black ink is shown in FIG. 5. In the description of the process, statements that the process is performing some task or function refers to a controller or general purpose processor executing programmed instructions stored in non-transitory computer readable medium operatively connected to the controller or processor to manipulate data or to operate one or more components in the printer to perform the task or function. The controller 80 noted above can be such a controller or processor. Alternatively, the controller can be implemented with more than one processor and associated circuitry and components, each of which is configured to perform one or more tasks or functions described herein. Additionally, the steps of the method may be performed in any feasible chronological order, regardless of the order shown in the figures or the order in which the processing is described.

The process 500 of FIG. 5 begins by processing the image data content to generate the color separations for each ink image in a print job and processing the print job parameters to determine the quality of black ink required throughout the print job, for each image, or within portions of the black color separation of each ink image (block 504). The process then determines the quality of the process black ink in the process black ink container using the numbers and quantities of each color of ink purged from the manifolds since the current startup (block 508). If the current process black ink quality is inadequate for the print job (block 512), then black (K) ink is provided from the black ink supply to the process black ink container in an amount that raises the process black ink to an appropriate level (block 516). Once the process black ink is appropriate for the print job, the print job is commenced and the black inkjets are operated with reference to the quality of black ink identified for the black color separations for the images or portions of the black color separations (block 520). When the end of the print job is finished (block 524), the process stops. Otherwise the process continues until the print job is finished.

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. An aqueous inkjet printer comprising:
a plurality of printheads;
a plurality of aqueous ink supplies, each printhead being fluidly connected to at least one of the ink supplies in the plurality of ink supplies and at least some of the ink supplies storing ink having a different color of ink than ink stored in at least some other ink supplies;
a first purged ink container that is fluidly connected to at least some of the printheads in the plurality of printheads to receive different colors of aqueous ink purged from a manifold in the printheads connected to the first purged ink container; and
at least one printhead in the plurality of printheads that is configured to eject black colored ink, the at least one printhead configured to eject black colored ink is fluidly connected to the first purged ink container to receive process black ink from the first purged ink container.

2. The aqueous inkjet printer of claim 1 further comprising:
a second purged ink container that is fluidly connected to a receptacle that receives ink purged through inkjets in the printheads, the second purged ink container being configured for removal from the inkjet printer to enable discarding of the ink purged through the inkjets in the printhead.

3. The aqueous inkjet printer of claim 2 further comprising:
a first valve fluidly connected to a supply of black ink in the plurality of ink supplies, to the first purged ink container, and to the at least one printhead that ejects black colored ink; and
a controller operatively connected to the first valve, the controller being configured to:
operate the first valve to provide the at least one printhead that ejects black colored ink black colored ink from the supply of black ink and process black ink from the first purged ink container selectively.

4. The aqueous inkjet printer of claim 3 further comprising:
a second valve fluidly connected to the supply of black ink and the first purged ink container; and
the controller is further configured to:
operate the second valve to provide black colored ink from the supply of black ink to the first purged ink container to alter the process black ink in the first purged ink container.

5. The aqueous inkjet printer of claim 4 wherein at least one of the printheads ejects black colored ink received the supply of black ink only and at least one other printhead ejects process black ink received from the first purged ink container only: and
the controller is operatively connected to the at least one printhead that ejects black colored ink only and to the at least one printhead that eject process black ink only, the controller being further configured to:
operate the at least one printhead that ejects black colored ink only and the at least one printhead that ejects process black ink only with reference to image content data and print job parameters.

6. The aqueous inkjet printer of claim 5, the controller being further configured to:
operate the at least one printhead that ejects black colored ink only for black color separations in a first group of ink images in a print job; and
operate the at least one printhead that ejects process black ink only for black color separations in a second group of ink images in the print job, all images in the first group of ink images being different from all ink images in the second group of ink images.

7. The aqueous inkjet printer of claim 5, the controller being further configured to:
operate the at least one printhead that ejects black colored ink only for portions of black color separations in ink images in a print job; and
operate the at least one printhead that ejects process black ink only for other portions of black color separations in the ink images in the print job, the portions of the black color separations printed with the printhead that ejects black colored ink only being different than the other portions of the black color separations printed with the printhead that ejects process black ink only.

8. The aqueous inkjet printer of claim 4, at least one printhead in the plurality of printheads further comprising:
a first array of inkjets that eject a first color of ink; and
a second array of inkjets that eject a second color of ink that is different than the first color of ink.

9. The aqueous inkjet printer of claim 8 wherein the first array of inkjets is fluidly connected to the first purged ink container.

10. The aqueous inkjet printer of claim 9, the controller being further configured to:
operate the first valve to connect the first array of inkjets to the supply of black ink and the first purged ink container selectively.

11. A method of operating an aqueous inkjet printer comprising:
fluidly connecting a first purged ink container to at least some printheads in the inkjet printer to receive different colors of aqueous ink purged from manifolds in the printheads connected to the first purged ink container; and
operating at least one printhead configured to receive process black ink from the first purged ink container to form at least a portion of a black color separation in ink images printed by the inkjet printer.

12. The method of claim 11 further comprising:
fluidly connecting a second purged ink container to a receptacle that receives aqueous ink purged through inkjets in the printheads; and
removing the second purged ink container from the inkjet printer to enable discarding of the ink purged through the inkjets in the printhead.

13. The method printer of claim 12 further comprising:
operating a first valve to connect the at least one printhead to a supply of black ink and the first purged ink container selectively.

14. The method of claim 13 further comprising:
operating a second valve to provide black ink from the supply of black ink to the first purged ink container to alter a process black ink stored in the first purged ink container.

15. The method of claim 14 further comprising:
operating at least one printhead that receives only black ink from the supply of black ink and operating at least one printhead that receives only process black ink from the first purged ink container with reference to image content data and print job parameters.

16. The method of claim 15 further comprising:
operating the at least one printhead that only receives black ink from the supply of black ink to print black color separations in a first group of ink images in a print job; and
operating the at least one printhead that only receives process black ink from the first purged ink container to print black color separations in a second group of ink images in the print job, all ink images in the first group of ink images are different from all ink images in the second group of ink images.

17. The method of claim 15 further comprising:
operating the at least one printhead that receives only black ink from the supply of black ink to print portions of black color separations in ink images in a print job; and
operating the at least one printhead that receives only process black ink from the first purged ink container to print other portions of black color separations in the ink images in the print job, the portions of the black color separations printed with the at least one printhead that receives only black ink from the black ink supply being different than the other portions of the black color separations printed with the at least one printhead that receives only process black ink.

18. The method of claim 14 further comprising:
ejecting a first color of ink from a first array of inkjets in at least one printhead in the inkjet printer; and
ejecting a second color of ink from a second array of inkjets in the at least one printhead in the inkjet printer, the second color of ink being different than the first color of ink.

19. The method of claim 18 further comprising:
fluidly connecting the first array of inkjets to the first purged ink container.

20. The method of claim 19 further comprising:
operating the first valve to connect the first array of inkjets to the supply of black ink and the first purged ink container selectively.
